(19) United States
(12) Patent Application Publication
(10) Pub. No.: US 2011/0202199 A1
(43) Pub. Date: Aug. 18, 2011

(54) Cargo Loading and Unloading System for a Vehicle

(76) Inventor: Steven Joesph Crane, Beverly, MA (US)

(21) Appl. No.: 12/707,807

(22) Filed: Feb. 18, 2010

(51) Int. Cl. B60P 1/16; G06F 19/00; B60P 1/44

(52) U.S. Cl. 701/2; 414/549

(57) ABSTRACT

A cargo loading and unloading system mounts to a vehicle's flat surface and is contained within the vehicle's constraints. The system includes a rolling platform attached to a tilting frame, which in turn pivots on top of a sliding extension frame, which in turn extends from a base frame. The extension frame is pushed toward the vehicle's rear. As the extension frame moves rearward, a tilt initiator lifts one end of the tilting frame from the flat surface, initiating tilting. The tilting frame continues to pivot upward about the vehicle's rear. The cargo platform rolls out or down to a loading or unloading surface. Once cargo is loaded or unloaded, the platform is raised back onto the tilting frame. The tilting frame pivots downwards towards the flat surface and lands on the extension frame. The extension frame is pulled back into the base frame.

### FIELD OF THE INVENTION

This invention relates to a system installed on the flat surface or in the bed of transport vehicles, including standard pickup trucks for the purpose of loading, transporting and unloading cargo.

### BACKGROUND OF INVENTION

There are many systems for transporting cargo that may be installed onto pickup trucks.

Several previously existing systems are designed to specifically load and unload certain types of cargo, such as personalized watercrafts, snowmobiles, all terrain vehicles (ATVs) or motorcycles. For example, U.S. Pat. No. 5,232,329, Livingston; U.S. Pat. No. 5,620,296, Mcmahon et al. and U.S. Pat. No. 6,152,674, Ogrodnick, all disclose cargo transport systems for lifting, transporting and unloading specialized cargo into the bed of a pickup truck. These systems lack flexibility as to what types of cargo they can unload or unload onto a pickup truck.

Other pickup truck cargo systems need to have cargo loaded at an extremely high position, from a forklift or the edge of a loading dock. For example, U.S. Patent Application No. 2006/0182573, Taylor and U.S. Pat. No. 5,328,320, Farrow et al. disclose cargo systems that cannot accept cargo loaded from the ground.

Other pickup truck cargo systems require extensive modification to standard pickup trucks in order to function. For example, U.S. Pat. No. 6,817,825, O'Hagen; and U.S. Pat. No. 7,300,239, Benedikt disclose cargo transport systems that require the removal of the entire truck bed to be installed.

In addition, U.S. Pat. No. 5,556,249, Heine; U.S. Pat. No. 5,829,945, Stanley; and U.S. Pat. No. 6,099,232, Dixon et al. disclose cargo transport systems that require the truck's tailgate to be removed in order for the system to function.

It is an object of the present invention to provide a cargo transport system that can be easily installed into the bed of a conventional pickup truck. The loading system of the present invention can be installed and operated without removing the truck's tailgate. The system can be operated by one person. The system is not limited to a single platform style. The system is not limited to size or capacity.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

One embodiment of the subject invention is a cargo loading and unloading system for a vehicle, wherein the system is set within the constraints of the vehicle and comprises: (a) a base frame removably attached to the vehicle in a substantially flat position with respect to the vehicle, wherein the base frame comprises a first end proximate to the front of the vehicle, a second end proximate to the rear of the vehicle, at least one base lateral member and a plurality of base cross members; (b) an extension frame mounted to the base frame, wherein the extension frame comprises a first end, a second end and at least one extension lateral member, the extension frame being slidably moveable between a forward position and a rearward position, wherein in the forward position, the first ends of both the base frame and the extension frame and the second ends of both the base frame and the extension frame are respectively aligned with each other in a substantially flat position; wherein in the rearward position the second end of the extension frame extends rearward of the vehicle; (c) a tilting frame mounted to the extension frame, wherein the tilting frame comprises, a first end, a second end, at least one tilting lateral member and a plurality of tilting cross members, the tilting frame being hingedly moveable between a down position and an up position, wherein in the down position, the first ends of both tilting frame and the extension frame and the second ends of both the tilting frame and the extension frame are respectively aligned with each other in a substantially flat position, wherein in the up position the first end of the tilting frame extends upwards away from the first end of the extension frame, and the tilting frame is pivoted at an angle between the first and second ends of the tilting frame, the pivot about an axis adjacent to or at the rear of the vehicle such that the second end of the tilting frame is proximate to a surface rearward of the vehicle, further wherein the axis is substantially perpendicular to the forward position and the rearward position movement of the extension frame; (d) means for slidably moving the extension frame between the forward position and the rearward position; (e) means for hingedly moving the tilting frame between the down position and the up position; (f) a tilt initiator mounted to the base frame, wherein as the extension frame is moved between the forward position and the rearward position, the tilting frame slides along with and on top of the extension frame, wherein the tilting frame begins moving from the down position to the up position upon engagement with the tilt initiator; (g) a cargo carrier mounted on the tilting frame, wherein the cargo carrier comprises a first end and a second end, the cargo carrier being slidably moveable between a first position and a second position, wherein in the first position, the first ends of both the cargo carrier and the tilting frame are aligned with each other, wherein in the second position the second end of the cargo carrier extends to the surface rearward of the vehicle; and (h) means for slidably moving the cargo carrier between the first position and the second position.

In a further embodiment of the subject invention, the means for slidably moving the extension frame between the forward position and the rearward position and the means for hingedly moving the tilting frame between the down position and the up position may comprise one mechanism.

In another embodiment of the subject invention, the means for slidably moving the extension frame between the forward position and the rearward position may comprise a hydraulic system comprising of at least one hydraulic cylinder.

In one embodiment of the subject invention, the means for hingedly moving the tilting frame between the down position and the up position comprises a hydraulic system may comprise of at least one hydraulic cylinder.

In an additional embodiment of the subject invention, the means for slidably moving the cargo carrier between the first position and the second position may be selected from a group consisting of at least one winch and a wire rope, chain and chain drive and rack and gear motor.

In a further embodiment of the subject invention, the system may further comprise a first plurality of stoppers to limit the movement of the extension frame between the forward position and the rearward position and a second plurality of stoppers to limit the movement of the cargo carrier between the first position and the second position.

In another embodiment of the subject invention, the system may further comprise at least one shock absorption device.

In one embodiment of the subject invention, the system may further comprise a user operated control unit to remotely activate the system.

In an additional embodiment of the subject invention, the system may further comprise a plurality of cargo securing points on the cargo carrier.

In a further embodiment of the subject invention, the system may further comprise a plurality of locking devices to secure the cargo carrier at specific points between the first position and the second position.

In one embodiment of the subject invention, the system may further comprise a plurality of outwardly extending rollers on the tilting lateral member that allows the cargo carrier to slide between the first position and the second position.

In a further embodiment of the subject invention, the vehicle may be selected from a group consisting of a light truck, medium truck, heavy truck, pick-up truck, utility vehicle, sport utility vehicle, wagon, station wagon, off-road vehicle, all terrain vehicle, golf cart, van, cargo van, panel van, pick up van, panel truck, canopy express, tow truck, flat bed tow truck, box truck, cutaway van chassis, bus, minibus, ambulance, school bus, delivery truck, motor home, shuttle bus, fire truck, flatbed truck, trailer, fifth wheel trailer, caravan, armored truck, dump truck, garbage truck and a tractor.

In another embodiment of the subject invention, the system may further comprise a plurality of locking devices to secure the tilting frame at specific points between the down position and the up position.

In an additional embodiment of the subject invention, the system may further comprise a plurality of locking devices to secure the extension frame at specific points between the forward position and the rearward position.

In another embodiment of the subject invention, the extension frame may further comprise a plurality of cross members.

In one embodiment of the subject invention, the tilt initiator may comprise at least one lift ramp attached on top of at least one of the base cross members and at least one rotatable ramp roller attached to one of the tilting cross members wherein as the extension frame is moved between the forward position and the rearward position, the tilting frame slides along with and on top of the extension frame until the ramp roller rotably engages the lift ramp such that the ramp roller rolls onto and up the lift ramp to initiate moving the tilting frame from the down position to the up position.

In a further embodiment of the subject invention, the tilt initiator may comprise at least one lever attached to at least one of the base cross members and at least one of the tilting cross members, wherein as the extension frame is moved between the forward position and the rearward position, the tilting frame slides along with and on top of the extension frame and the lever leverages the tilting frame initiating the movement of the tilting frame from the down position to the up position.

In another embodiment of the subject invention, the system may further comprise a winch and wire rope for loading and unloading cargo onto the cargo carrier.

In an additional embodiment of the subject invention, the constraints of the vehicle may comprise standard enclosures of a mass produced vehicle, further wherein system of claim 1 may be attached to the vehicle without modification to the standard enclosures.

In a further embodiment of the subject invention, the surface rearward of the vehicle may be selected from a group consisting of a dock, the ground, water or the flat surface of a second vehicle.

Another embodiment of the subject invention comprises a cargo loading and unloading system for a vehicle having a flat surface, wherein the system is set within the constraints of the vehicle and comprises: a base frame removably attached to the flat surface , wherein the base frame comprises at least one base lateral member and a plurality of base cross members; an extension frame slidably mounted to the base frame such that the extension frame may move in one direction with respect to the base frame, wherein the extension frame comprises at least one extension lateral member and a plurality of extension cross members; a tilting frame hingedly mounted to the extension frame, wherein the tilting frame comprises at least one tilting lateral member and a plurality of tilting cross members, further wherein a closed position of the tilting frame is on top of and substantially parallel to the base frame; at least one rotatable ramp roller attached to one of the tilting cross members; at least one lift ramp attached on top of one of the base cross members; means for pushing the tilting frame towards a back end of the vehicle, wherein as the tilting frame approaches the back end, the extension frame extends towards the back end and the ramp roller rotably engages the lift ramp such that the ramp roller rolls onto and up the lift ramp as the tilting frame is continually pushed, the lift ramp causes one end of the tilting frame to pivot upwards away from the flat surface; a cargo carrier mounted on the tilting frame such that the cargo carrier may move in one direction with respect to the tilting frame; and means connecting the cargo carrier and the tilting frame for controlling the movement of the cargo carrier between the ground and the flat surface of the vehicle, wherein when the tilting frame is extended and at an angle with the flat surface of the vehicle, the means lowers the cargo carrier towards the ground.

In a further embodiment of the subject invention, the means for pushing the tilting frame may comprise a hydraulic system comprising of at least one hydraulic cylinder.

In another embodiment of the subject invention, the means connecting the cargo carrier and the tilting frame for controlling movement of the cargo carrier may comprise a winch and a wire rope.

In an additional embodiment of the subject invention, the system may further comprise a plurality of bearing stoppers to limit the movement of the extension frame.

In one embodiment of the subject invention, the system may further comprise at least one shock absorption device.

In a further embodiment of the subject invention, the system may further comprise a user operated control unit to remotely activate the means for pushing the tilting frame.

In an additional embodiment of the subject invention, the system may further comprise a user operated control unit to remotely activate the means connecting the cargo carrier and the tilting frame

In a further embodiment of the subject invention, the system may further comprise a plurality of cargo securing points on the cargo carrier.

In another embodiment of the subject invention, the system may further comprise a plurality of locking devices to secure the cargo carrier at specific positions on the tilting frame.

In a further embodiment of the subject invention, the system may further comprise a plurality of outwardly extending rollers on the tilting lateral member that allows the cargo carrier to move freely in one direction with respect to the tilting frame.

In one embodiment of the subject invention, the vehicle is a trailer.

In a further embodiment of the subject invention, the flat surface may be selected from a group consisting of a bed and a frame in which a flat surface can be constructed.

In an additional embodiment of the subject invention, the plurality of base cross members may be substantial perpendicular to the base lateral member.

In another embodiment of the subject invention, the plurality of base cross members may be substantial diagonal to the base lateral member.

In a further embodiment of the subject invention, the plurality of extension cross members may be substantial perpendicular to the extension lateral member.

In one embodiment of the subject invention, the plurality of extension cross members may be substantial diagonal to the extension lateral member.

In an additional embodiment of the subject invention, the plurality of tilting cross members may be substantial perpendicular to the base lateral member.

In another embodiment of the subject invention, the plurality of tilting cross members may be substantial diagonal to the tilting lateral member.

In a further embodiment of the subject invention, the system may further comprise a plurality of locking devices to secure the tilting frame at specific positions on the base frame.

In an additional embodiment of the subject invention, the system may further comprise a plurality of locking devices to secure the extension frame at specific positions on the base frame.

One embodiment of the subject invention is a cargo loading and unloading system for a bed of a pickup truck, said system comprising: (a) a base frame attached within the bed such that a tailgate of the bed can be opened and closed, wherein the base frame comprises a pair of substantially parallel base lateral members, and a plurality of base cross members, further wherein at least one side of each of the base lateral members further comprises a sliding track; (b) a sliding extension frame slidably mounted on the base frame, wherein the sliding extension frame comprises a pair of extension lateral members that are substantially parallel with each other and the base lateral members, further wherein the sliding extension frame is adapted to move in a substantially straight direction away from the truck cab towards the tailgate along the sliding tracks when the system is operated into an open position and towards the truck cab along the sliding tracks when the system is operated into a closed position; (c) a pair of lift ramps attached on top of one of the base cross members between the base lateral members, wherein the lift ramps are substantially parallel to the base lateral members; (d) a tilting frame comprising a pair of substantially parallel tilting lateral members, wherein the tilting frame further comprises first, second and third tilting cross members that are each connected at a first end to one of the tilting lateral member and at a second end to the other tilting lateral member, further wherein the tilting frame is in a substantially flat position on top of the base frame within the bed when the system is in the closed position, wherein the first tilting cross member is attached to a winch and is proximate to the truck cab, the second tilting cross member is pivotally attached to the base frame proximate to the tailgate and the third tilting cross member is attached to two rotatable ramp rollers; (e) a pair of hydraulic cylinders each attached at one end to one of the base cross members proximate to the truck cab, wherein each hydraulic cylinder comprises a piston attached to the third tilting cross member, such that when an operator activates the hydraulic cylinders to move the system into the open position, the pistons push the tilting frame which causes the sliding extension frame to slide in a substantially straight direction away from the truck cab towards the tailgate along the sliding tracks, further wherein as the tilting frame approaches the tailgate, the ramp rollers rotably engage the lift ramps such that both ramp rollers roll onto and up the lift ramps as the pistons continue to push the tilting frame, the lift ramps cause one end of the tilting frame to pivot upwards away from the bed about the pivot connection to the base frame on the other end of the tilting frame, wherein the sliding extension frame stops movement and the one end of the tilting frame continues to pivot upwards away from the bed until the pistons are fully extended; and (f) a platform positioned over the tilting frame, wherein the platform is attached to a winch by a wire rope; further wherein when the tilting frame is fully extended and at an angle with the bed, the winch lowers the platform towards the ground, wherein the tilting lateral members each comprise a plurality of outwardly extending rotatable platform rollers that allow the platform to extend from the bed, further wherein the tilting lateral members comprise outwardly extending rotatable guide wheels that roll on a pair of opposite inner surfaces of the platform.

In a further embodiment of the subject invention, the system may comprise moving the system into a closed position, wherein the operator activates the winch to pull the platform by the attached wire rope into a raised position onto the pivoted tilting frame, wherein the plurality of outwardly extending rotatable platform rollers allow the platform to retract into the bed and the outwardly extending rotatable guide wheels roll on the pair of opposite inner surfaces of the platform, further wherein the pistons are activated to pull the tilting frame such that the tilting frame pivots downwards towards the bed, wherein the ramp rollers rotably engage the lift ramps such that both ramp rollers roll onto and down the lift ramps as the pistons continue to pull the tilting frame, further wherein the pulled tilting frame causes the sliding extension frame to slide in a substantially straight direction towards the truck cab away from the tailgate along the sliding tracks until the tilting frame is in the substantially flat position on top of the base frame within the bed.

In another embodiment of the subject invention, the system may further comprise a plurality of slide surface mounts attaching the sliding extension frame to the base frame.

In an additional embodiment of the subject invention, the system may comprise two or more lift ramps. In a further embodiment of the subject invention, the lift ramps may be connected to a second base cross member.

In another embodiment of the subject invention, the winch may be connected to a second base cross member. In another embodiment of the subject invention, the winch and the wire rope may be used to load and unload cargo onto the platform.

In a further embodiment of the subject invention, the system may comprise a plurality of locking devices that lock the platform in the closed position. In another embodiment of the subject invention, the system may comprise a plurality of locking devices that lock the platform in the opened position.

In one embodiment of the subject invention, the system may comprise a user operated control unit to remotely activate hydraulic cylinders.

Another embodiment of the subject invention is cargo transporting system for a vehicle having a bed, a pair of spaced side walls extending upwardly from the bed and a tail gate defining a cargo compartment, said system comprising: (a) a base frame attached within the bed such that the tailgate can be opened and closed, wherein the base frame comprises at least one base lateral member, and a plurality of base cross members, further wherein the base lateral member further comprises at least one sliding track; (b) a sliding extension frame slidably mounted on the base frame, wherein the sliding extension frame comprises at least one extension lateral member, further wherein the sliding extension frame is adapted to move away from a truck cab towards the tailgate along the sliding track when the system is operated into an open position and towards the truck cab along the sliding track when the system is operated into a closed position; (c) at least one lift ramp attached on top of one of the base cross members; (d) a tilting frame comprising at least one tilting lateral member, wherein the tilting frame further comprises a plurality of tilting cross members, further wherein the tilting frame is on top of the base frame within the bed when the system is in the closed position, wherein the tilting frame is pivotally attached to the base frame proximate to the tailgate; (e) at least one rotatable ramp roller attached to one of the tilting cross members; (f) means interconnecting the tilting frame and the base frame for pushing the tilting frame away from the truck cab towards the tailgate, wherein as the tilting frame approaches the tailgate, the ramp roller rotably engages the lift ramp such that the ramp roller rolls onto and up the lift ramp as the tilting frame is continually pushed, the lift ramp causes one end of the tilting frame to pivot upwards away from the bed about the pivot connection to the base frame; (g) a platform for carrying cargo positioned over the tilting frame; and (h) means connecting the platform and the tilting frame for controlling the movement of the platform between the ground and the bed, wherein when the tilting frame is extended and at an angle with the bed, the means lowers the platform towards the ground.

A further embodiment of the subject invention is a cargo transporting system for a vehicle having a bed, a pair of spaced side walls extending upwardly from the bed and a tail gate defining a cargo compartment, said system comprising: (a) a base frame attached within the bed such that the tailgate can be opened and closed, wherein the base frame comprises a plurality of lateral members and a plurality of base cross members, further wherein each of the base lateral members further comprises at least one sliding track; (b) a sliding extension frame slidably mounted on the base frame, wherein the sliding extension frame comprises a plurality of extension lateral members, further wherein the sliding extension frame is adapted to move away from a truck cab towards the tailgate along the sliding tracks when the system is operated into an open position and towards the truck cab along the sliding tracks when the system is operated into a closed position; (c) a plurality of lift ramps attached on top of the base cross members; (d) a tilting frame comprising a plurality of tilting lateral members, wherein the tilting frame further comprises a plurality of tilting cross members, further wherein the tilting frame is on top of the base frame within the bed when the system is in the closed position, wherein the tilting frame is pivotally attached to the base frame proximate to the tailgate; (e) a plurality of rotatable ramp rollers attached to the tilting cross members; (f) means interconnecting the tilting frame and the base frame for pushing the tilting frame away from the truck cab towards the tailgate, wherein as the tilting frame approaches the tailgate, the ramp rollers rotably engages the lift ramps such that the ramp rollers roll onto and up the lift ramps as the tilting frame is continually pushed, the lift ramps cause one end of the tilting frame to pivot upwards away from the bed about the pivot connection to the base frame; (g) a platform for carrying cargo positioned over the tilting frame; and (h) means connecting the platform and the tilting frame for controlling the movement of the platform between the ground and the bed, wherein when the tilting frame is extended and at an angle with the bed, the means lowers the platform towards the ground.

One embodiment of the subject invention a cargo transporting system for a vehicle having a bed, said system comprising: (a) a base frame attached within the bed, wherein the base frame comprises at least one base lateral member, and a plurality of base cross members; (b) a sliding extension frame slidably mounted on the base frame, wherein the sliding extension frame comprises at least one extension lateral member; (c) at least one lift ramp attached on top of one of the base cross members; (d) a tilting frame comprising at least one tilting lateral member, wherein the tilting frame further comprises a plurality of tilting cross members, further wherein the tilting frame is on top of the base frame within the bed, wherein the tilting frame is pivotally attached to the base frame; (e) at least one rotatable ramp roller attached to one of the tilting cross members; (f) means interconnecting the tilting frame and the base frame for pushing the tilting frame away from the truck cab towards the tailgate, wherein as the tilting frame approaches the tailgate, the ramp roller rotably engages the lift ramp such that the ramp roller rolls onto and up the lift ramp as the tilting frame is continually pushed, the lift ramp causes one end of the tilting frame to pivot upwards away from the bed about the pivot connection to the base frame; (g) a platform for carrying cargo positioned over the tilting frame; and (h) means connecting the platform and the tilting frame for controlling the movement of the platform between the ground and the bed, wherein when the tilting frame is extended and at an angle with the bed, the means lowers the platform towards the ground.

In further embodiments of the subject invention, the means interconnecting the tilting frame and the base frame may be one or more hydraulic cylinders.

In other embodiments of the subject invention, the means connecting the platform and the tilting frame for controlling movement of the platform between the ground and the bed may be a winch and a wire rope.

In additional embodiments of the subject invention, the system may further comprise a plurality of slide surface mounts attaching the sliding extension frame to the base frame.

In further embodiments of the subject invention, the base frame may be attached to the frame of the truck.

In other embodiments of the subject invention, the system may further comprise a plurality of slide stoppers to stop movement of the sliding extension frame.

In additional embodiments of the subject invention, the system may further comprise a plurality of tie downs on the platform.

In further embodiments of the subject invention, the system may further comprise a plurality of tie down rails on the platform.

In even embodiments of the subject invention, the system may further comprise one or more shock pads on the lift ramp.

In other embodiments of the subject invention, the system may further comprise a user operated control unit to remotely activate the means interconnecting the tilting frame and the base frame.

In additional embodiments of the subject invention, the system may further comprise a user operated control unit to remotely activate the means connecting the platform and the tilting frame for controlling movement of the platform between the ground and the bed.

In further embodiments of the subject invention, the system may further comprise a plurality of locking devices for the tilting frame.

In other embodiments of the subject, the system may further comprise a plurality of outwardly extending rotatable platform rollers on the tilting lateral members that allow the platform to extend from the bed.

In additional embodiments of the subject invention, the system may further comprise a plurality of outwardly extending rotatable guide wheels on the tilting lateral members that roll on a pair of opposite inner surfaces of the platform. In further embodiments of the subject invention, the system may comprise a plurality of outwardly extending rotatable platform rollers on the tilting lateral members that allow the platform to extend from the bed.

In other embodiments of the subject invention, the platform may include a plurality of handles for tying down cargo items.

In additional embodiments of the subject invention, the platform may include a gripping surface for receiving and supporting cargo items.

There has thus been broadly outlined the more important features of the invention in order that the detailed description thereof that follows may be better understood, and in order that the present contribution to the art may be better appreciated. There are additional features of the invention that will be described hereinafter and which will form the subject matter of the claims appended hereto. These together with other embodiments of the invention, and with various features of novelty which characterize the invention, are pointed out with particularity in the claims annexed to and formed as part of this disclosure.

For a conceptual understanding of the invention, its operational advantages and the specific embodiments refer to the accompanying drawings and descriptive matter in which there are embodiments of the invention illustrated. Other features and advantages of the present invention will become apparent from the following description of embodiment(s), taken in conjunction with the accompanying drawings, which by way of example; illustrate the principles of the invention.

### BRIEF DESCRIPTION OF THE DRAWINGS

Advantages of the present invention will be apparent from the following detailed description of embodiments thereof, which description should be considered in conjunction with the accompanying drawings of which, unless otherwise specified, the platform is shown and the loading system is attached, and in which:

FIG. 1 illustrates an isometric view of the cargo loading and unloading system in an open or extended position attached to the bed of a truck.

FIG. 2 illustrates an isometric view of the unattached cargo loading and unloading system in an open or extended position without the cargo platform.

FIG. 3 illustrates an isometric view of the unattached cargo loading and unloading system in an open or extended position with the cargo platform lowered.

FIG. 4 illustrates an isometric view of the unattached cargo loading and unloading system in a closed or retracted position without the cargo platform.

FIG. 5 illustrates an isometric view of the unattached cargo loading and unloading system in a closed or retracted position with the cargo platform on top.

FIG. 5a illustrates an isometric view of the top of the cargo loading and unloading system,

FIG. 6 illustrates an isometric view of the base frame of the cargo loading and unloading system.

FIG. 7 illustrates an isometric view of the extension frame of the cargo loading and unloading system.

FIG. 8 illustrates an isometric view of the tilting frame of the cargo loading and unloading system.

FIG. 9 illustrates a top view of the unattached cargo loading and unloading system in a closed or retracted position with the cargo platform.

FIG. 10 illustrates a top view of the unattached cargo loading and unloading system in a closed or retracted position without the cargo platform.

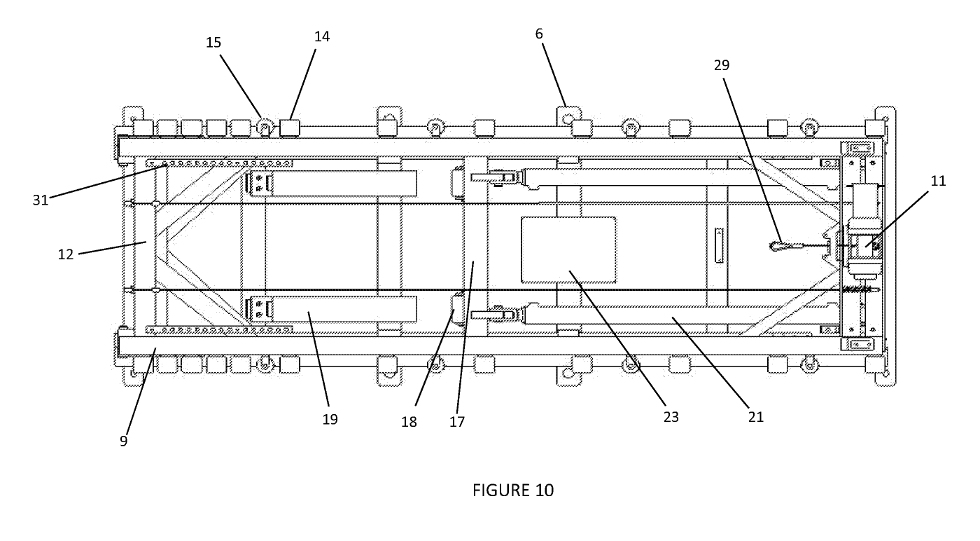

FIG. 11 illustrates a bottom view of the unattached cargo loading and unloading system in a closed or retracted position without the cargo platform.

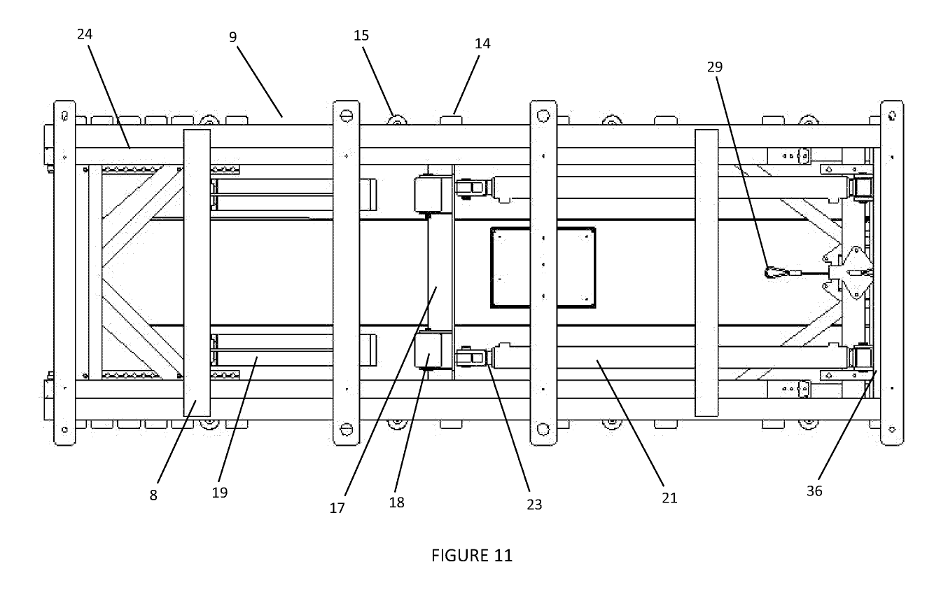

FIG. 12 illustrates a back view of the unattached cargo loading and unloading system in a closed or retracted position.

FIG. 13 illustrates a front view of the unattached cargo loading and unloading system in a closed or retracted position.

FIG. 14 illustrates a side view of the unattached cargo loading and unloading system in a closed or retracted position with the cargo platform on top.

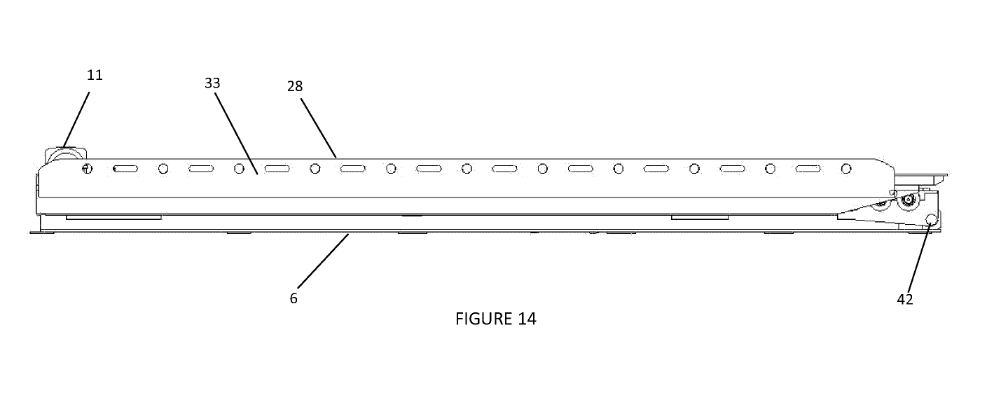

FIG. 15 illustrates a side view of the unattached cargo loading and unloading system in a closed or retracted position without the cargo platform.

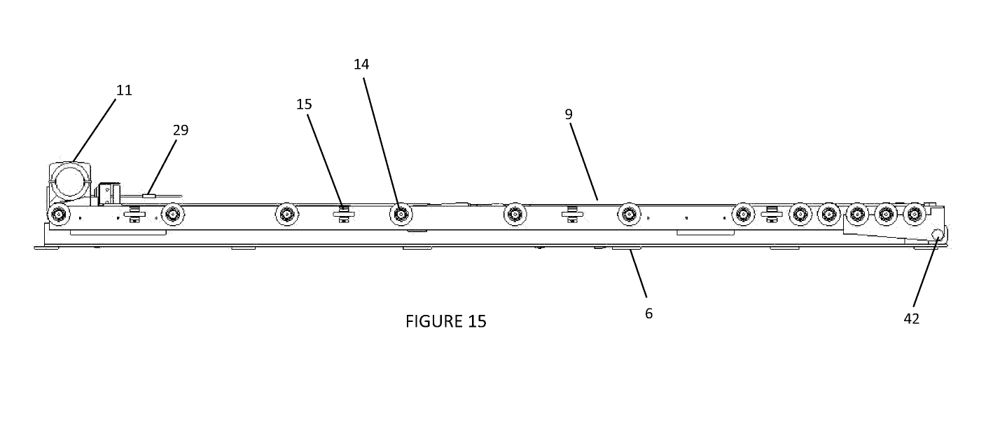

FIG. 16 illustrates a side view of the unattached cargo loading and unloading system in open position without the cargo platform.

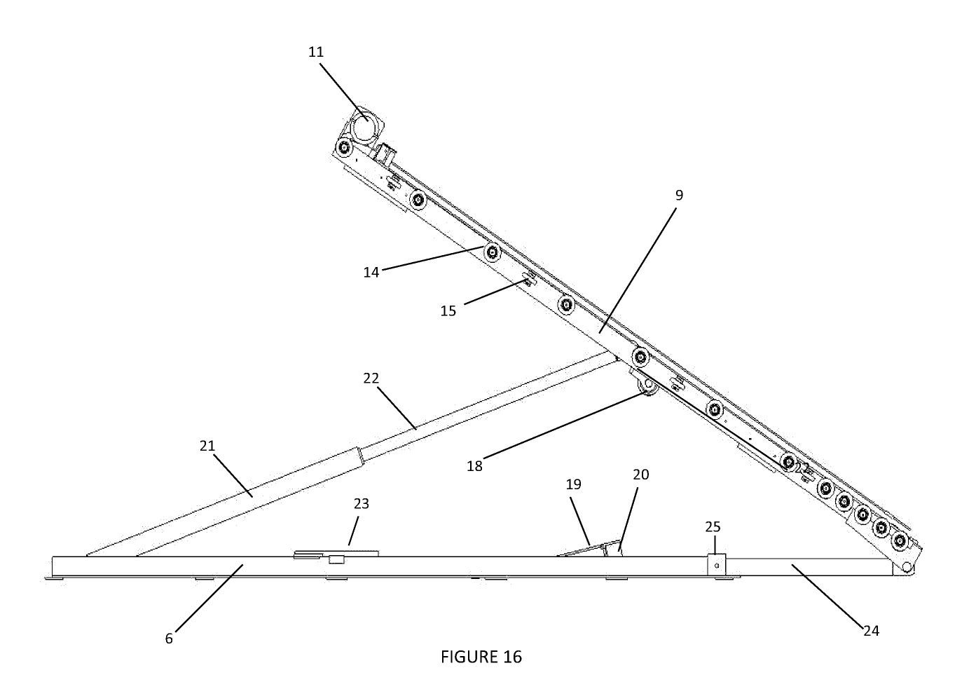

FIG. 17 illustrates a top view, with reference to the cargo platform, of the unattached cargo loading and unloading system in an open or extended position.

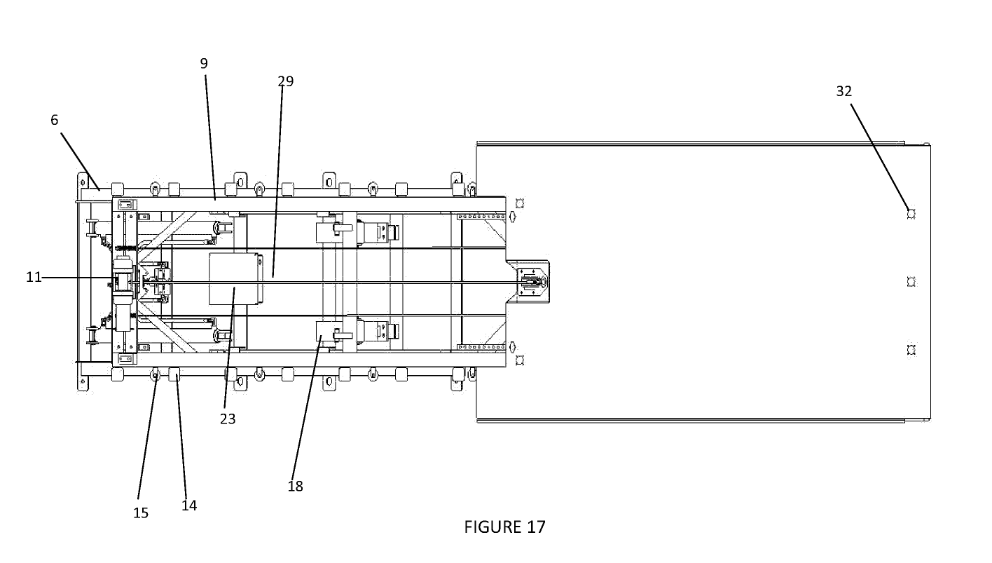

FIG. 18 illustrates a top view, with reference to the base frame, of the unattached cargo loading and unloading system in an open or extended position.

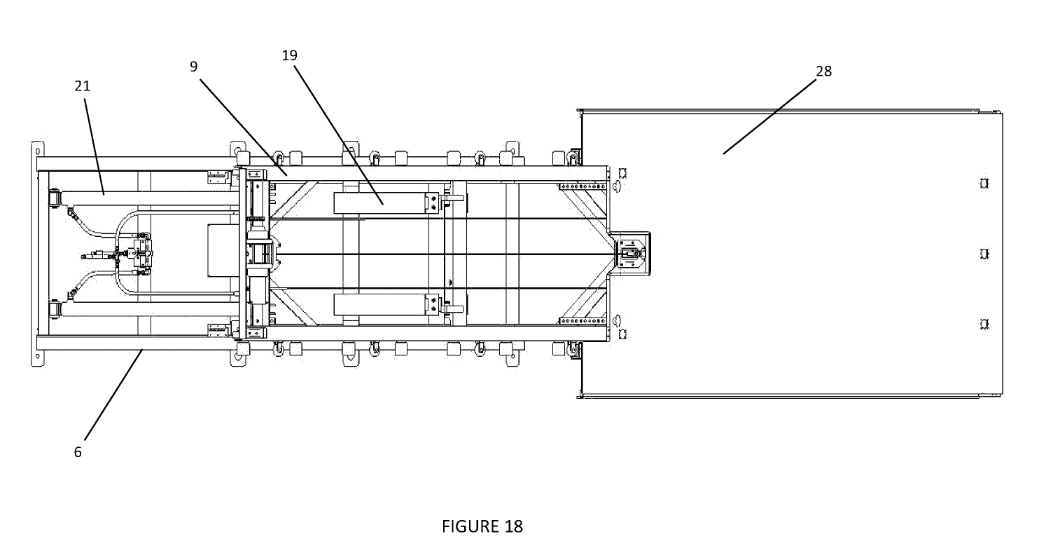

FIG. 19 illustrates a side view of the cargo loading and unloading system, attached to the bed of a truck, in a closed or retracted position with the truck tailgate closed.

FIG. 20 illustrates an isometric view of the cargo loading and unloading system, attached to the bed of a truck, in a closed or retracted position with the truck tailgate closed.

FIG. 21 illustrates a side view of the cargo loading and unloading system, attached to the bed of a truck, in a closed or retracted position with the truck tailgate opened.

FIG. 22 illustrates an isometric view of the cargo loading and unloading system, attached to the bed of a truck, in a closed or retracted position with the truck tailgate opened.

FIG. 23 illustrates a side view of the cargo loading and unloading system, attached to the bed of a truck, in a tilted or raised position with the platform not extended.

FIG. 24 illustrates an isometric view of the cargo loading and unloading system, attached to the bed of a truck, in a tilted or raised position with the platform not extended.

FIG. 25 illustrates a side view of the cargo loading and unloading system, attached to the bed of a truck, in an open or extended position.

FIG. 26 illustrates an isometric view of the cargo loading and unloading system, attached to the bed of a truck, in an open or extended position.

FIG. 27 illustrates a side view of the cargo loading and unloading system, attached to the bed of a truck, in which the tilting frame has engaged the lift ramps.

FIG. 28 illustrates an isometric view of the cargo loading and unloading system, attached to the bed of a truck, in which the tilting frame has engaged the lift ramps.

FIG. 29 illustrates a cross sectional view of the cargo loading and unloading system, attached to the bed of a truck, in which the tilting frame has engaged the lift ramps.

FIG. 29a illustrates a detailed view of the cross sectional view (FIG. 29) of the cargo loading and unloading system in which the ramp rollers 18 roll up ramps 19.

FIG. 30 illustrates an isometric view of the base and extension frames mounted to the frame of a truck, through the truck bed (the truck bed is not shown for clarity).

### DETAILED DESCRIPTION OF THE EMBODIMENTS

While several variations of the present invention have been illustrated by way of example in embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

The subject invention comprises a loading and unloading system that may be installed within the bed of a standard pickup truck.

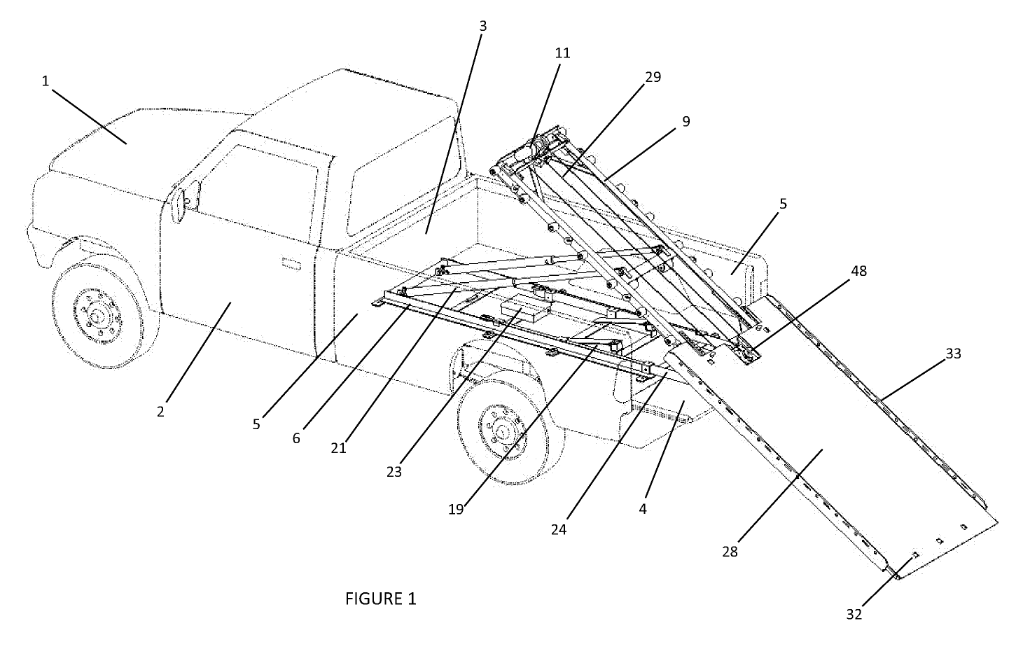

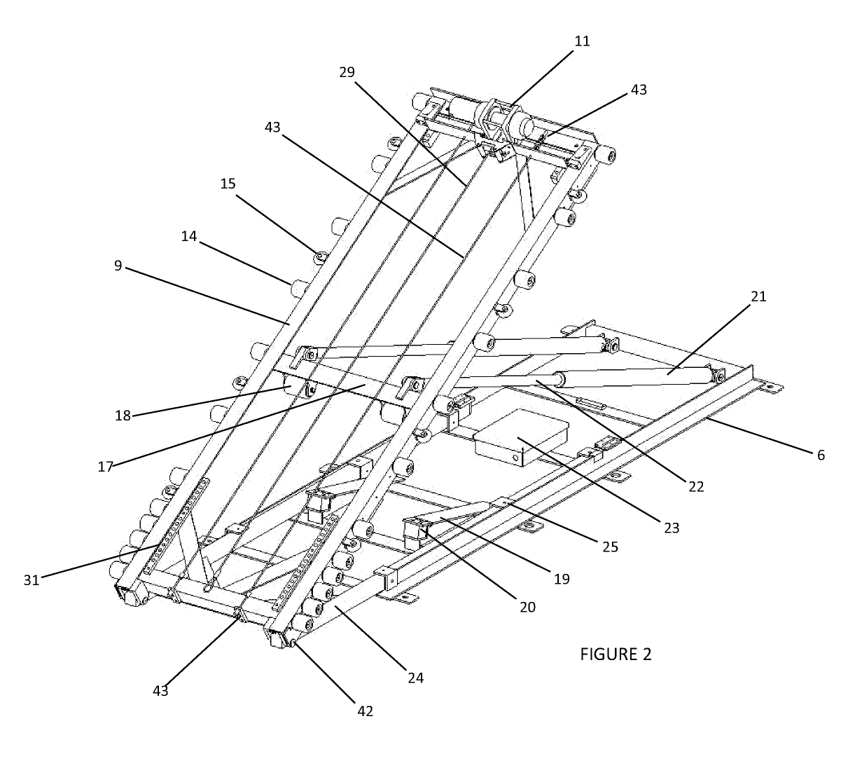

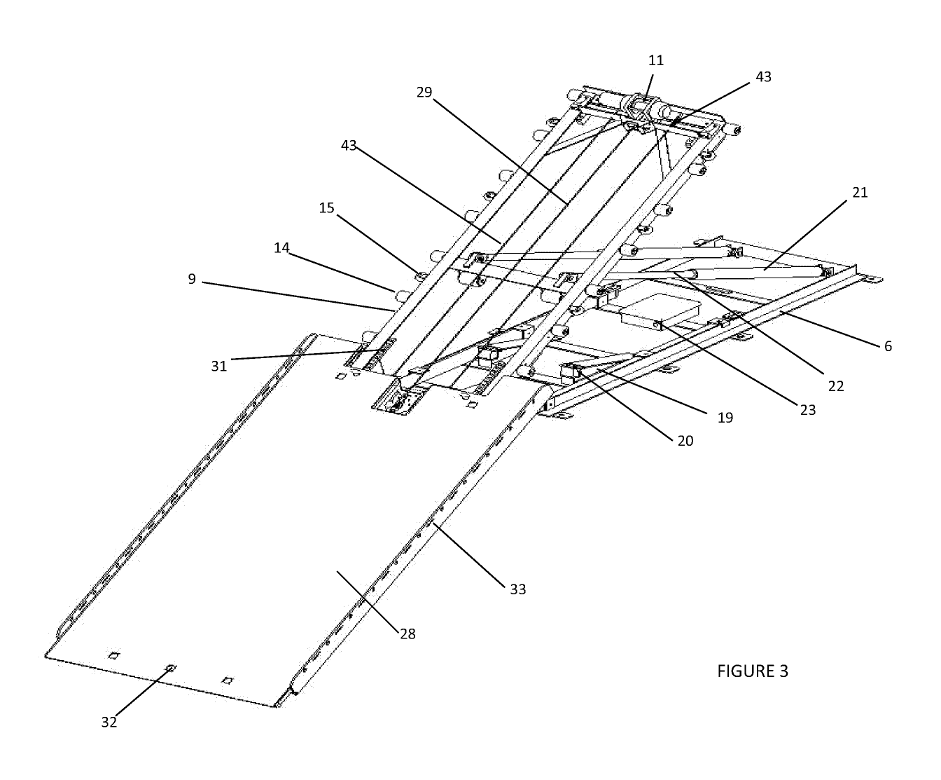

FIGS. 1-3 illustrate an embodiment of the subject invention in an open or extended position for loading or unloading cargo. FIG. 1 illustrates the invention attached to the bed of a pickup truck, while FIGS. 2 and 3 illustrate the invention unattached to any vehicle.

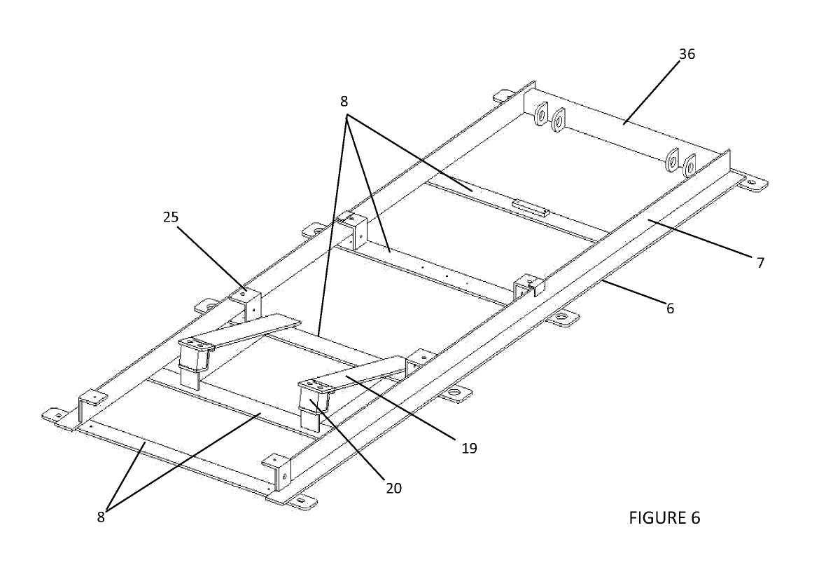

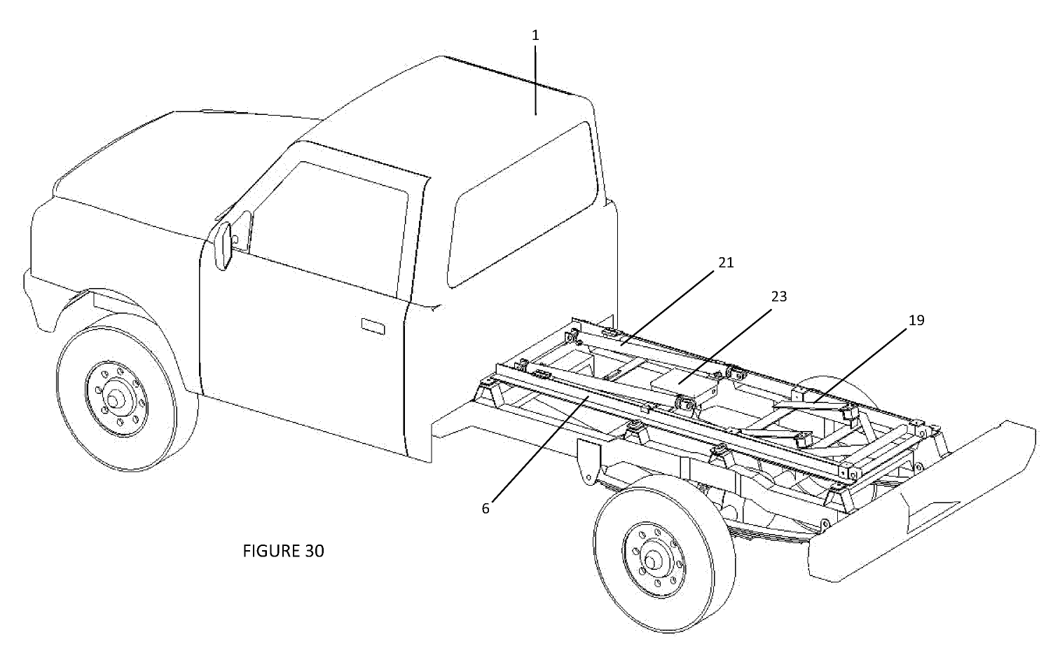

As shown in FIG. 1, a standard pickup truck 1 contains a truck cab 2, truck bed 3, tailgate 4 and vertical sides 5 of the truck bed 3. Base frame 6 of the system, shown separately in FIG. 6, is attached within truck bed 3 to the frame of truck 1. FIG. 30 illustrates the attachment of the base frame 6 to the truck frame with the truck bed removed.

Base frame 6 comprises lateral members 7 and cross members 8 and 36. Base frame 6 is attached to truck bed 3 such that lateral members 7 run substantially parallel with vertical sides 5 of truck bed 3. The inner sides of lateral members 7 comprise bearing surfaces 25 for containing an extension frame 24. The bearing surfaces 25 allow the extension frame 24 to slide in two directions, both of which are substantially parallel to lateral members 7 of base frame 6.

Base frame 6 also contains two lift initiation ramps 19 that run substantially parallel to and are between lateral members 7 of base frame 6. Ramps 19 are connected to base frame 6 on two cross members 8. Ramps 19 incorporate hinged rubber shock absorption pads 20 at the apex of the ramps 19.

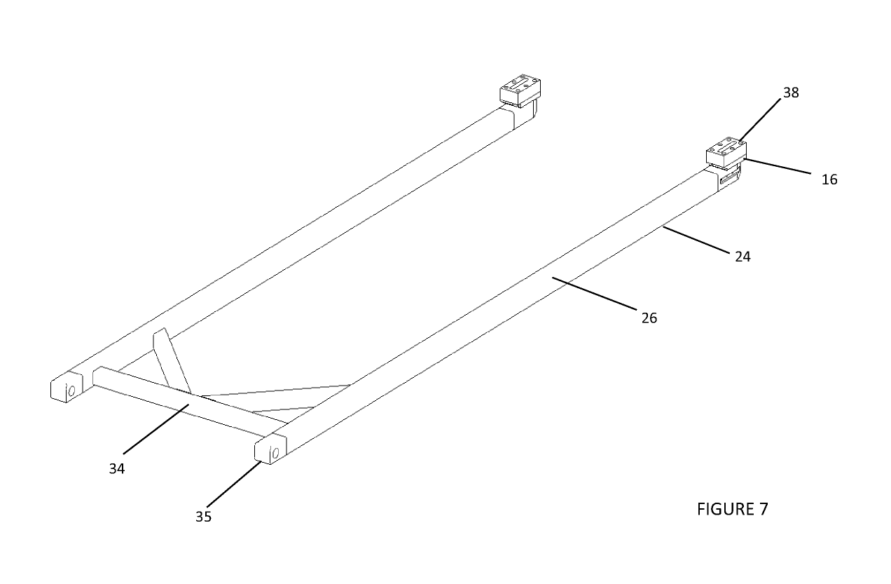

Extension frame 24, shown separately in FIG. 7, is attached within the bearing surfaces 25 of the base frame 6. Extension frame 24 comprises lateral members 26 that run substantially parallel to lateral members 7 of base frame 6. Extension frame 24 further comprises reinforcing members 34 and hinge pin receivers 35 that attach to tilting frame 9. Extension frame 24 also comprises of slide stops 16, that limit its sliding movement, and rubber shock absorbing pads 38.

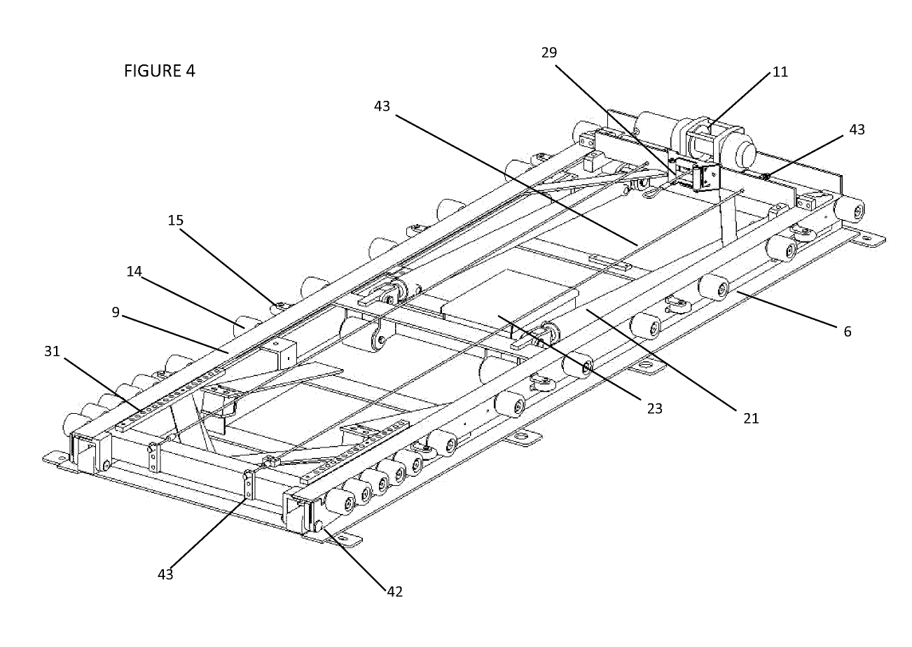

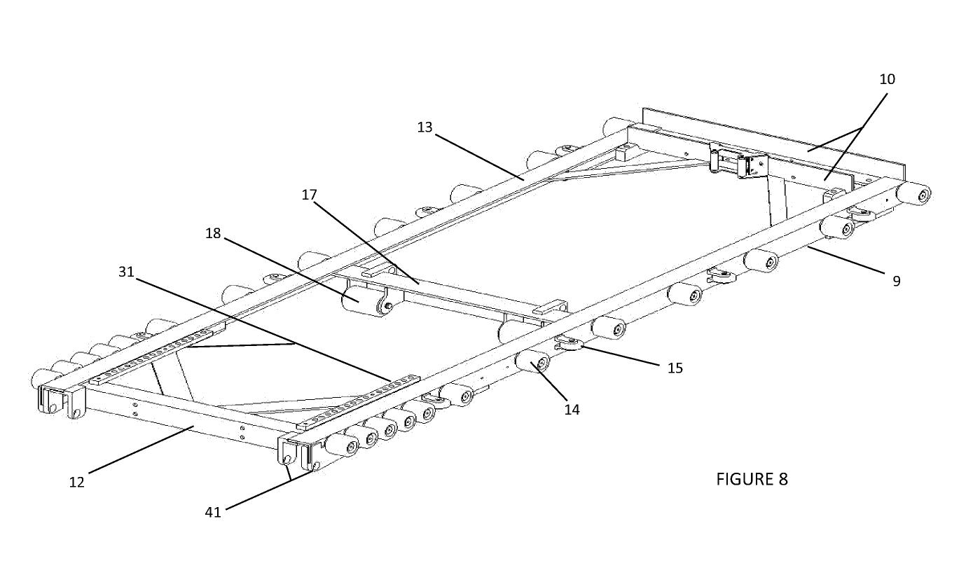

Tilting frame 9, shown separately in FIG. 8, comprises lateral members 13 that run substantially parallel to lateral members 7 of base frame 6. Tilting frame 9 also comprises of two hinge pin receivers 41. Hinge pin receivers 41, extension frame hinge pin receivers 35 and hinge pins 42 form a pivot point for the tilting movement of tilting frame 9 (see FIGS. 2 and 4).

Tilting frame 9 also comprises of two cross members 10, which attach winch 11 and are located proximate to the truck cab 2. Tilting frame 9 further comprises a third cross member 12 located proximate to the rear of the truck 1 and to tailgate 4. Tilting frame 9 also comprises a fourth midframe cross member, or lift initiation roller beam 17. Roller beam 17 contains two ramp rollers 18.

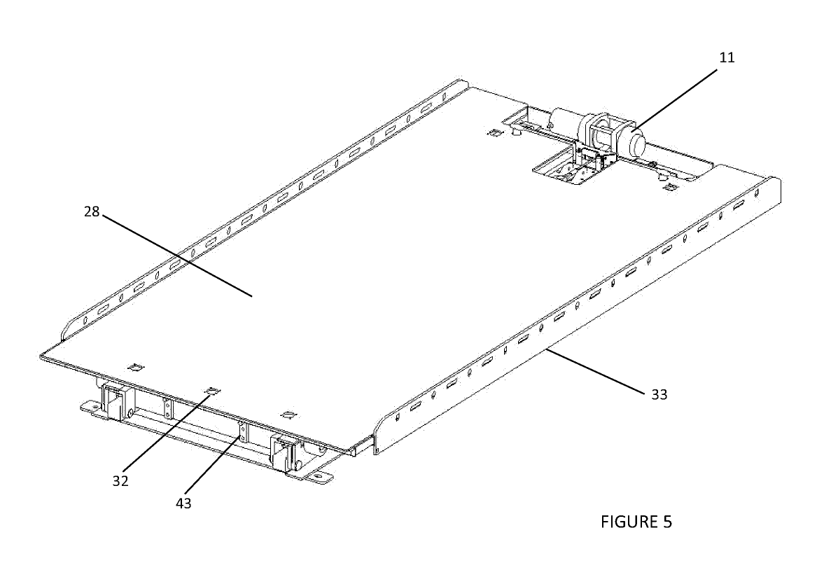

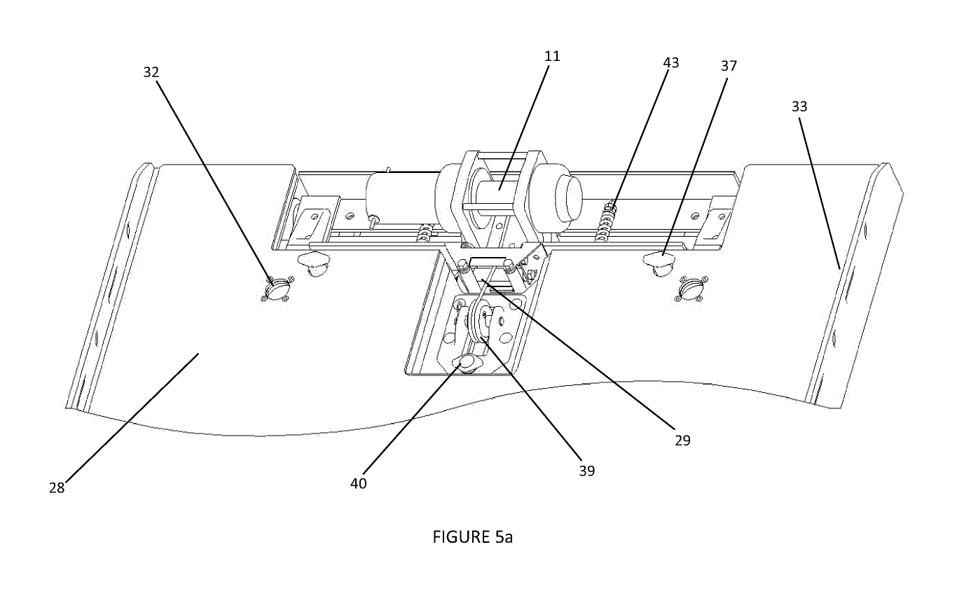

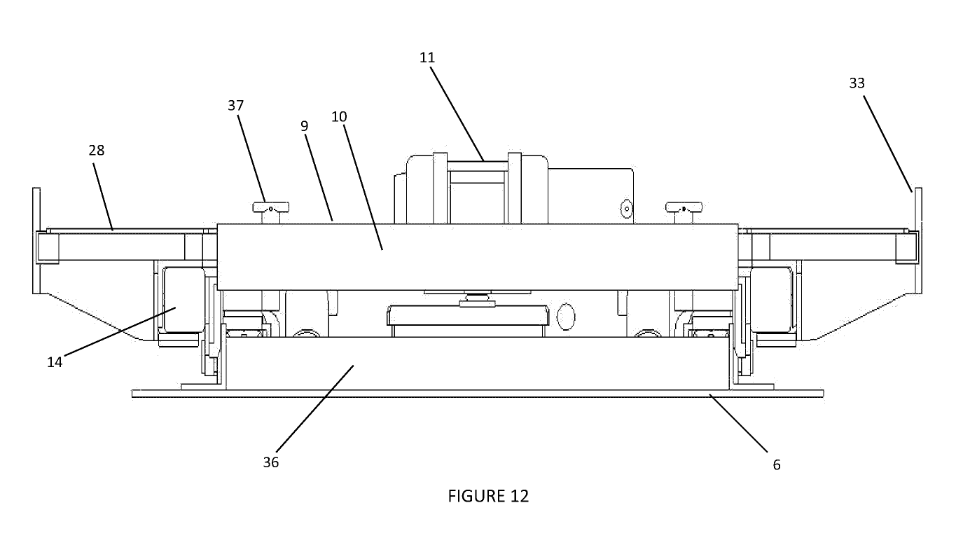

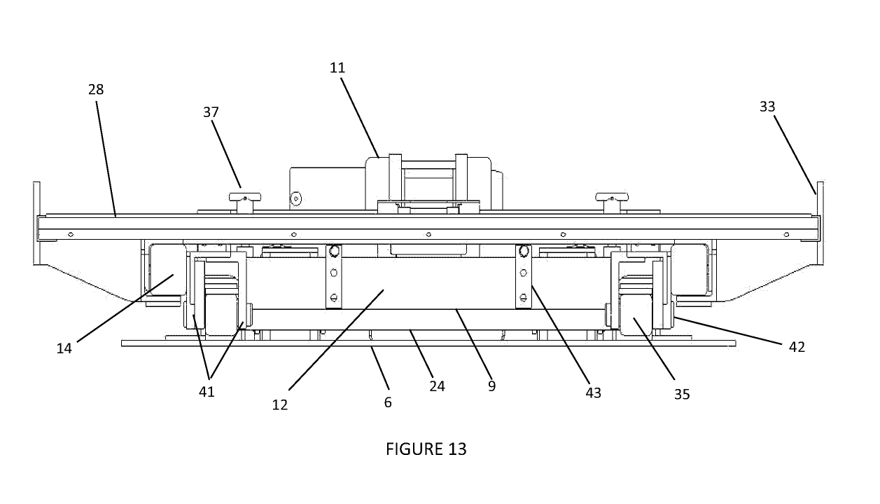

Lateral members 13, of tilting frame 9, comprise outwardly extending platform roller assemblies 14 and guide wheels 15. Roller assemblies 14 allow platform 28, shown in FIG. 5, to extend and retract in the horizontal plane. Guide wheels 15 are positioned to roll on the inner surface of the platform 28 and to guide platform's movement so that it is substantially parallel to lateral members 7 of base frame 6 (see FIGS. 12 and 13).

As shown in FIG. 2, hydraulic cylinders 21 are pivot pinned to the end cross member 36 of base frame 6 and proximate to the truck cab 2. Pistons 22 of cylinders 21 are pivot pinned to roller beam 17 of tilting frame 9. Hydraulic pump (not shown) is attached elsewhere to truck 1.

The subject invention operates in the following manner to load and unload cargo (not shown) from the truck bed 3 of a standard pickup truck 1.

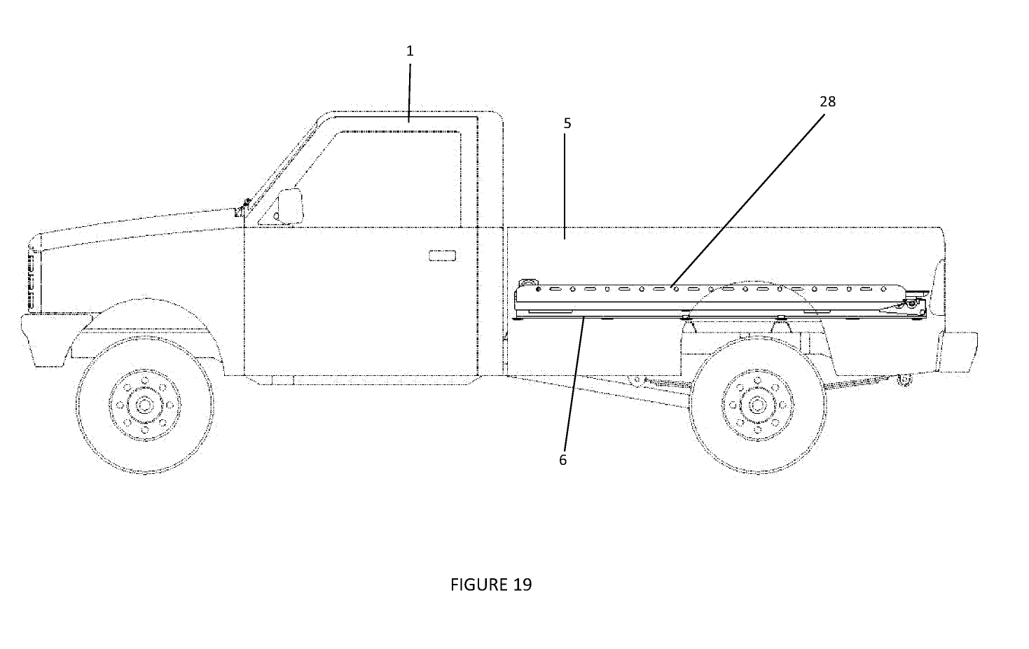

As shown in FIGS. 19-22, the loading system is in a closed, locked, substantially flat position within the truck bed 3 when the system is not in use or is transporting cargo (not shown) secured to the top of platform 28.

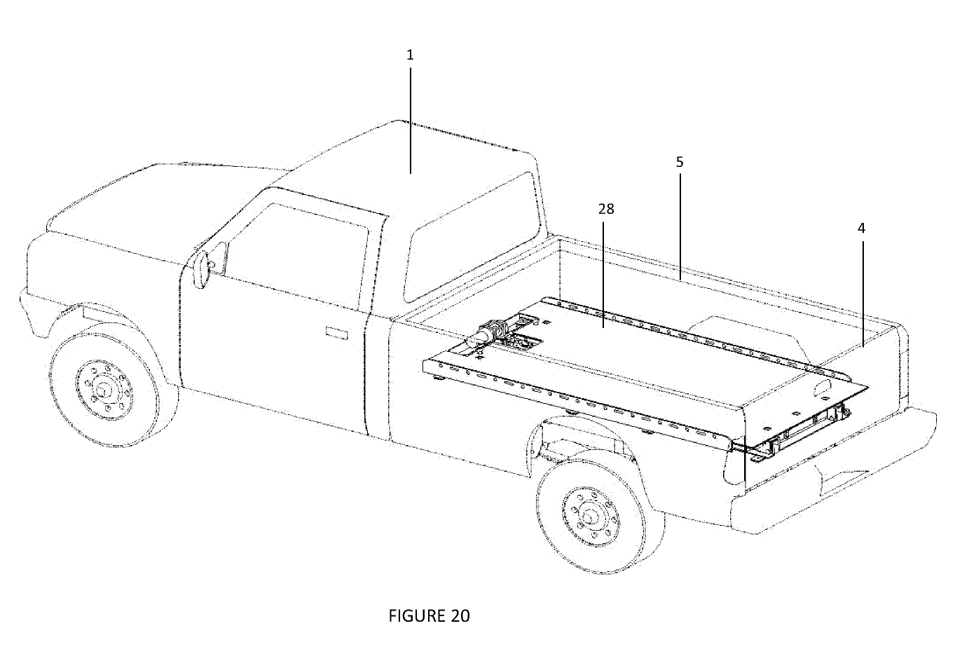

FIGS. 19 and 20 show the system in the “closed” or retracted position. In this position, the system is contained entirely within the truck bed 3 such that tailgate 4 may be opened and closed normally without adjustment.

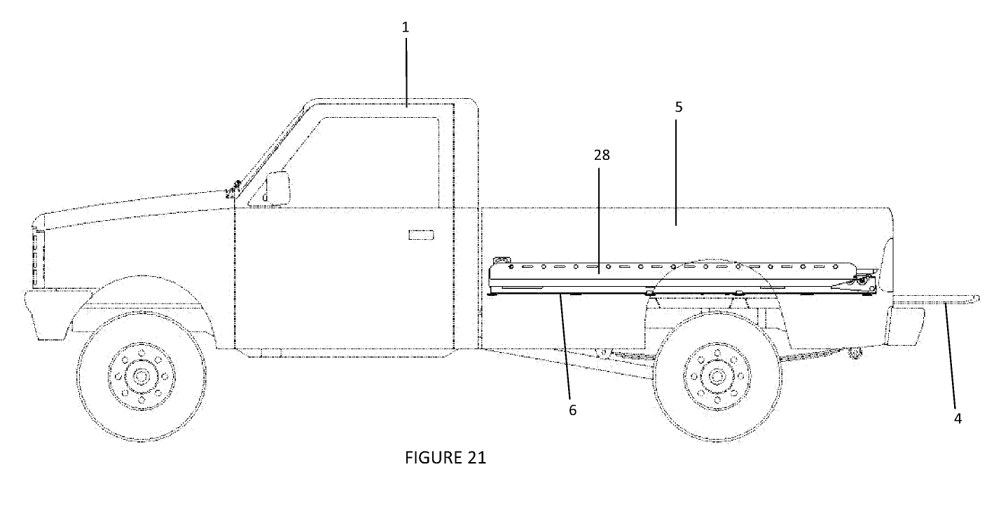

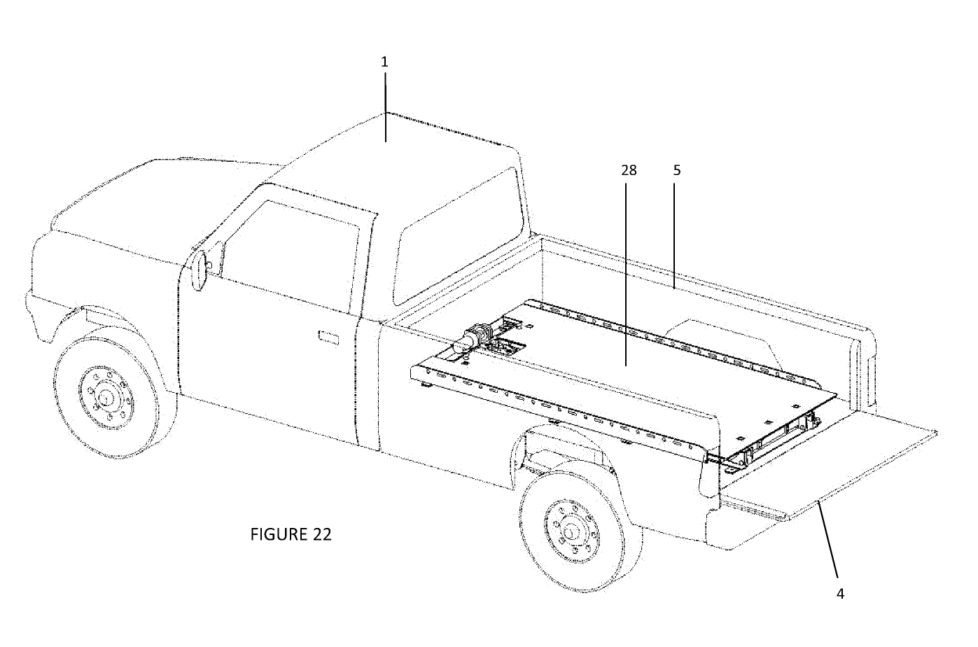

To load or unload cargo using the system, a user first opens tailgate 4 and unlocks the locking devices 37 of platform 28 (see FIGS. 21 and 22). A user then remotely activates control unit 23 on base frame 6 to activate hydraulic cylinders 21. Pistons 22 of cylinders 21 push tilting frame 9 which causes extension frame 24 to slide through bearing surfaces 25 on base frame 6 in a direction away from truck cab 2. This direction is towards and through the space of the opened tailgate 4.

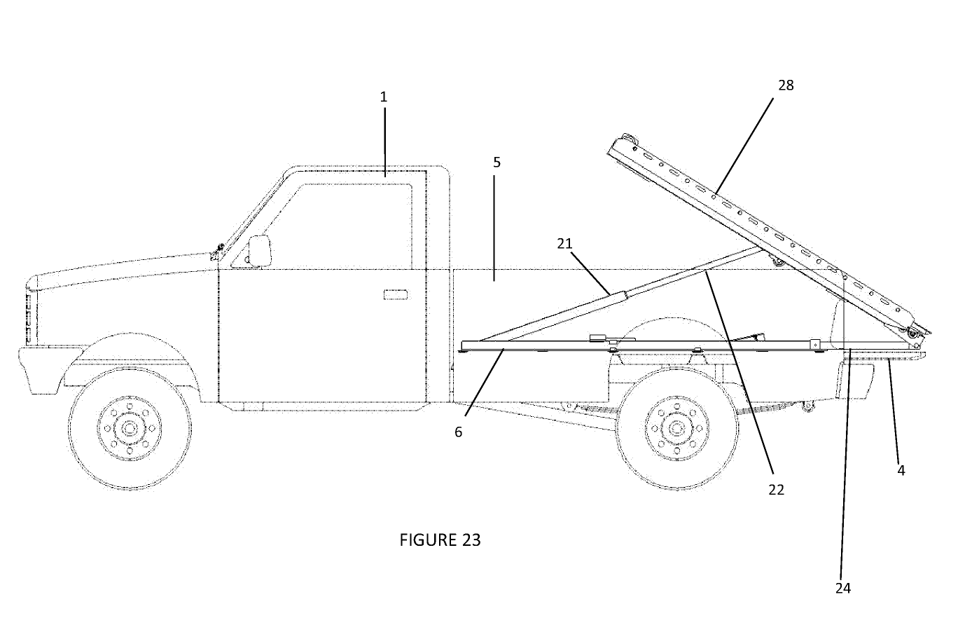

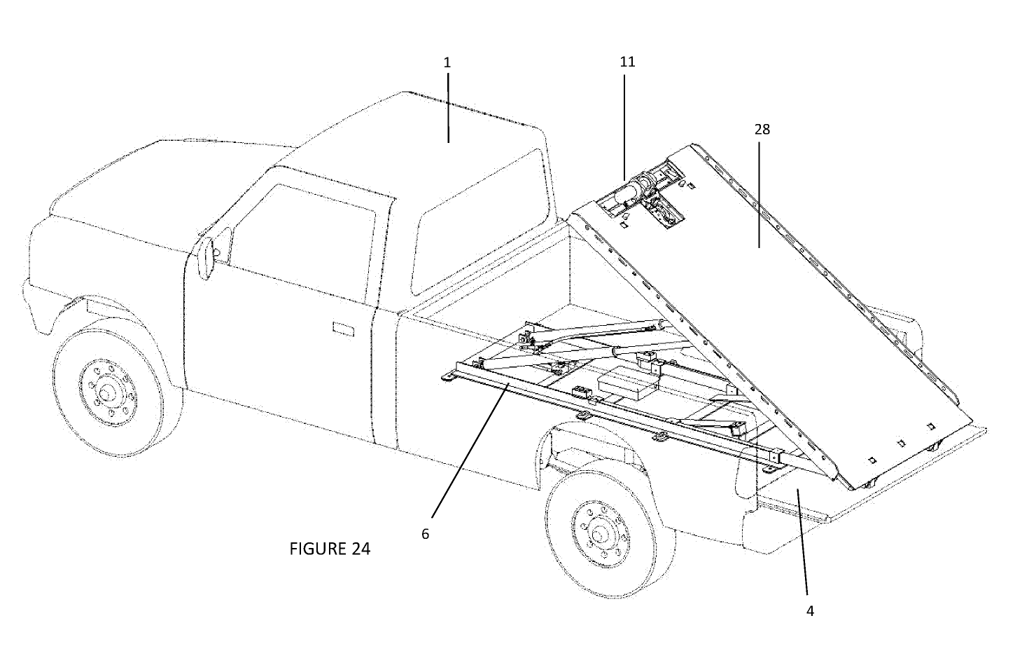

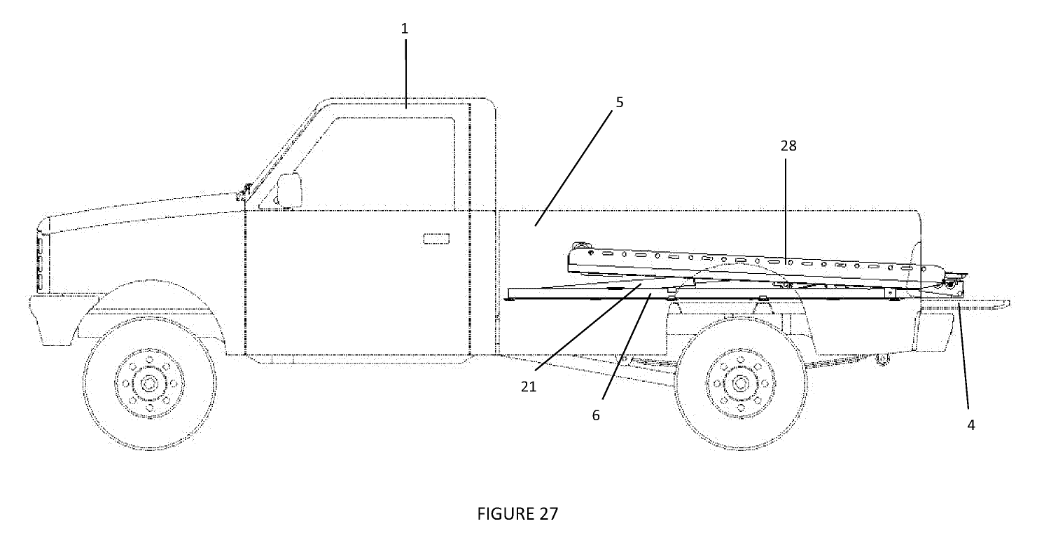

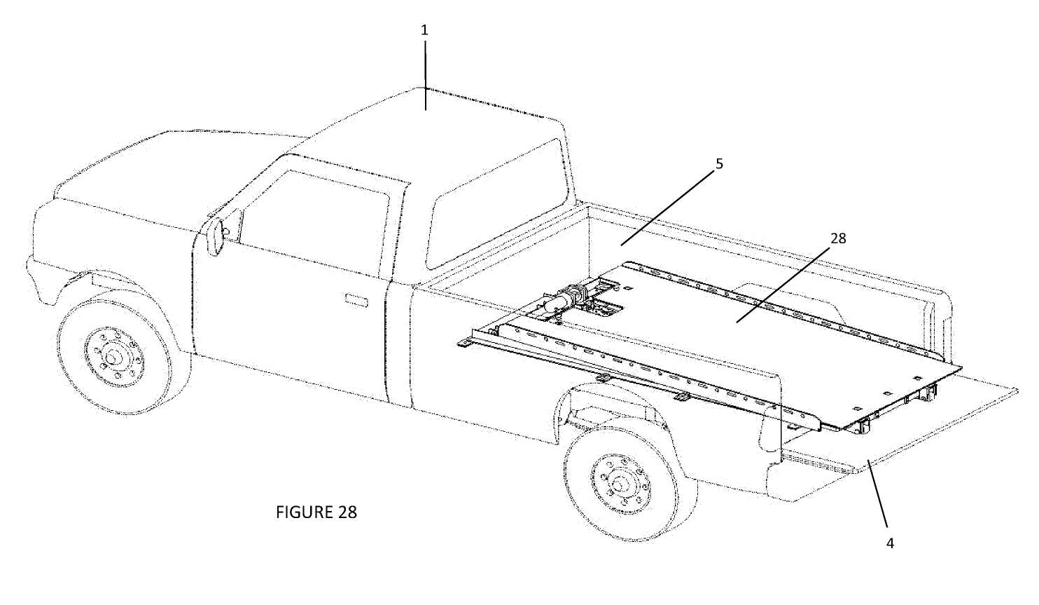

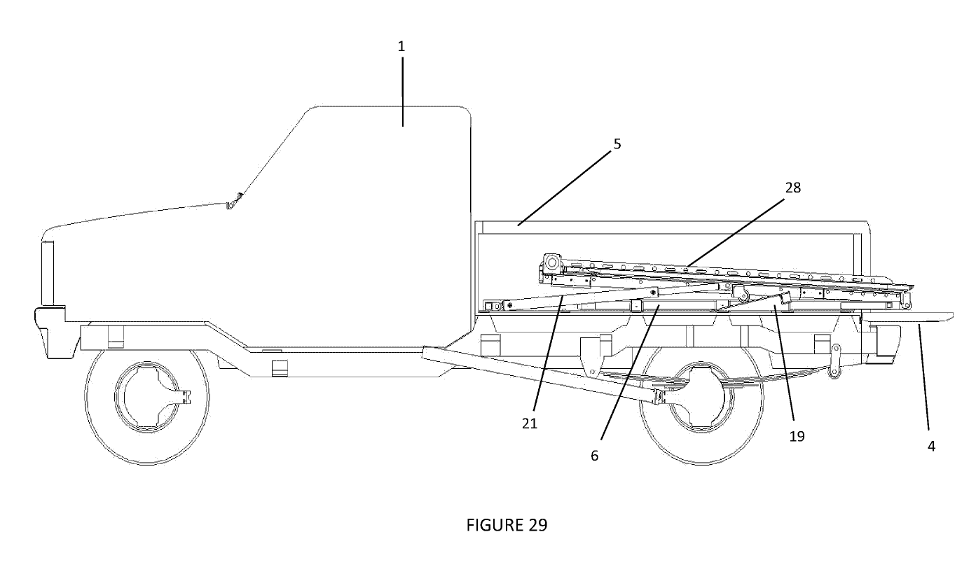

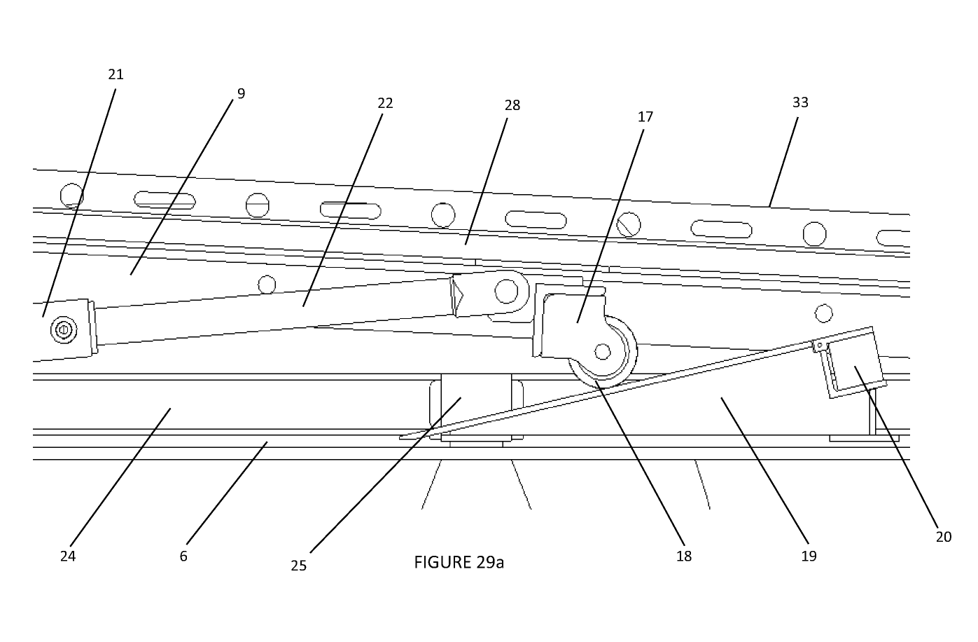

As tilting frame 9 approaches the space of the opened tailgate 4, ramp rollers 18 on roller beam 17 engage lift initiation ramps 19, as shown in FIGS. 27-29a. Ramp rollers 18 roll onto and up ramps 19 as pistons 22 continue to push on roller beam 17. Ramps 19 cause one end of tilting frame 9 to pivot upwards away from truck bed 3. Tilting frame 9 pivots about a pivot point formed by hinge pin receivers 41, extension frame hinge pin receivers 35 and hinge pins 42. At the full extension of extension frame 24, slide stops 16 halt any further sliding movement of extension frame 24 and the ramp rollers 18 reach the top of the ramps 19 causing tilting frame 9 to continue to rotate upwards away from the truck bed 3. Tilting frame 9 continues to rotate upwards until the hydraulic pistons 22 are fully extended. FIGS. 23 and 24 show the hydraulic pistons 22 fully extended with tilting frame 9 and platform 28 at an angle with respect to the truck bed 3.

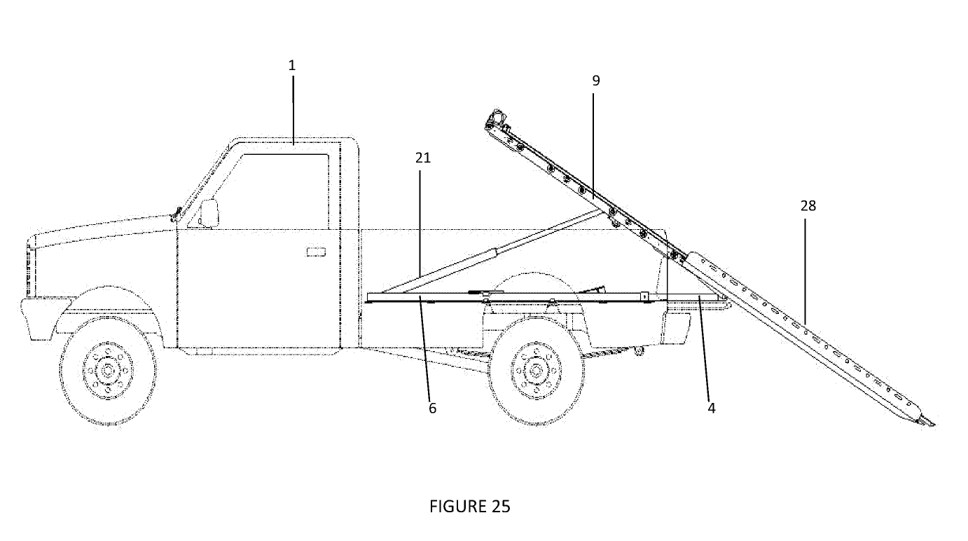

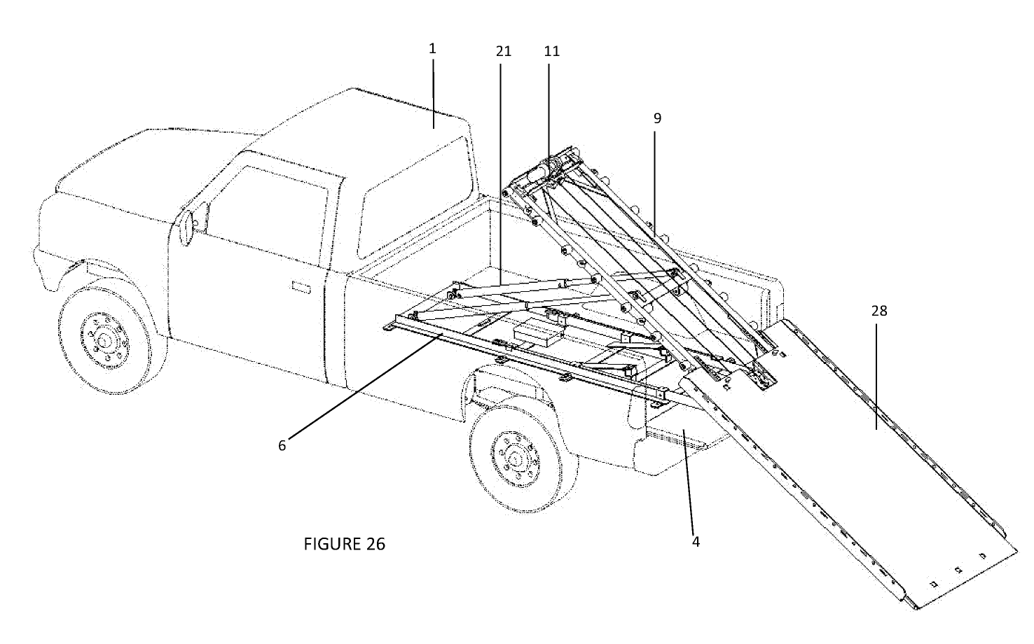

As shown in FIGS. 23 and 24, platform 28 is positioned over tilting frame 9, and is at an angle with respect to the flat truck bed 3. A user remotely activates control unit 23 on base frame 6 to activate winch 11. As shown in FIGS. 25 and 26, winch 11 lowers platform 28 to the ground via gravity through a connecting wire rope 29. The platform 28 is locked in the extended position by inserting platform locking devices 37 into the variable stop attachment 31 locking positions on tilting frame 9. Platform 28 is prevented from separating from the system by removable stop locks 43 which also incorporate shock absorbing springs.

In the open or loading position of the system, shown in FIGS. 1, 25 and 26, tilting frame 9 and platform 28 form an upward ramp from the ground to the truck bed 3. Winch 11 may be used to assist in the loading of the cargo by disconnecting wire rope 29 from the platform clevis 40 and connecting it to the cargo (not shown). Pulley 39 can also be used to raise or lower platform 28 at a slower rate or for heavier loads.

Once the cargo is loaded or unloaded, and the cargo (not shown) is secured to tie down anchors 32 and tie down rails 33 with ties, the system is returned to the closed position. If winch 11 was used to assist in the loading of the cargo, wire rope 29 is reconnected to platform 28.

A user unlocks the platform locking devices 37 and activates the control unit 23 to pull platform 28 upwards from the ground by the connected wire rope 29 and winch 11.

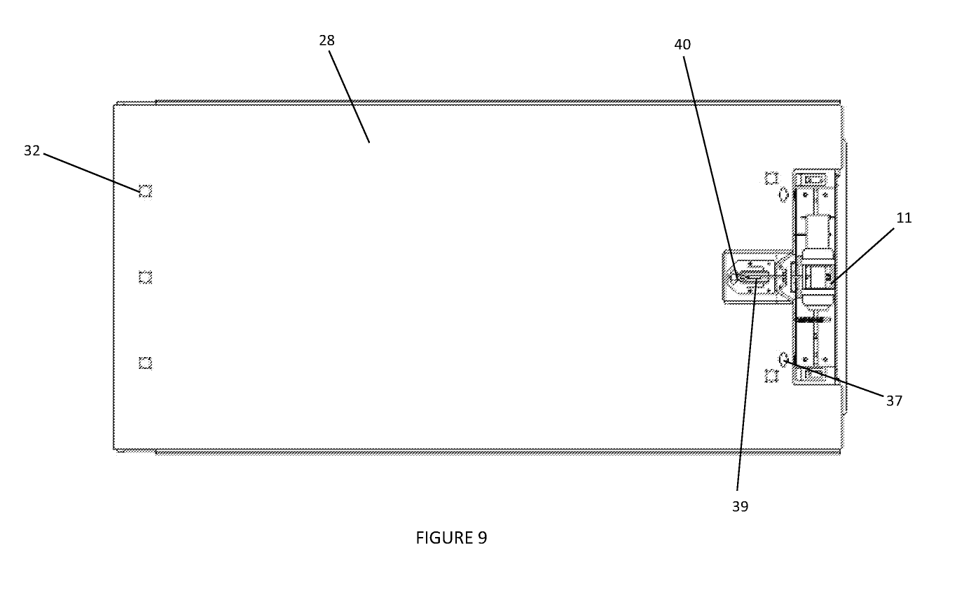

A user then remotely activates control unit 23 on base frame 6 to activate hydraulic cylinders 21. Pistons 22 of cylinders 21 pull tilting frame 9 so that it pivots downward towards the truck bed 3. As tilting frame 9 pivots downward, ramp rollers 18 on roller beam 17 land onto rubber shock absorption pads 20 of ramps 19. Extension frame 24 begins to slide into the truck bed 3 through the space of the opened tailgate 4. Ramp rollers 18 roll down ramps 19 until tilting frame 9 lands on shock absorption pads 38 on extension frame 24. Pistons 22 continue to retract tilting frame 9 and extension frame 24 until the pistons 22 are fully retracted, and tilting frame 9 reaches the closed position of the system. In this closed position, shown in FIGS. 5 and 9, platform 28 lies substantially flat on top of tilting frame 9, which lies substantially flat on base frame 6. The platform locking devices 37 lock the system in the “closed” position. The entire system is contained within the truck bed 3, so the tailgate 4 may be closed normally.

What is claimed is:

1. A cargo loading and unloading system for a vehicle, wherein the system is set within the constraints of the vehicle and comprises:
(a) a base frame removably attached to the vehicle in a substantially flat position with respect to the vehicle, wherein the base frame comprises a first end proximate to the front of the vehicle, a second end proximate to the rear of the vehicle, at least one base lateral member and a plurality of base cross members;
(b) an extension frame mounted to the base frame, wherein the extension frame comprises a first end, a second end and at least one extension lateral member, the extension frame being slidably moveable between a forward position and a rearward position, wherein in the forward position, the first ends of both the base frame and the extension frame and the second ends of both the base frame and the extension frame are respectively aligned with each other in a substantially flat position, wherein in the rearward position the second end of the extension frame extends rearward of the vehicle;
(c) a tilting frame mounted to the extension frame, wherein the tilting frame comprises, a first end, a second end, at least one tilting lateral member and a plurality of tilting cross members, the tilting frame being hingedly moveable between a down position and an up position, wherein in the down position, the first ends of both tilting frame and the extension frame and the second ends of both the tilting frame and the extension frame are respectively aligned with each other in a substantially flat position; wherein in the up position the first end of the tilting frame extends upwards away from the first end of the extension frame, and the tilting frame is pivoted at an angle between the first and second ends of the tilting frame, the pivot about an axis adjacent to or at the rear of the vehicle such that the second end of the tilting frame is proximate to a surface rearward of the vehicle, further wherein the axis is substantially perpendicular to the forward position and the rearward position movement of the extension frame;
(d) means for slidably moving the extension frame between the forward position and the rearward position;
(e) means for hingedly moving the tilting frame between the down position and the up position;
(f) a tilt initiator mounted to the base frame, wherein as the extension frame is moved between the forward position and the rearward position, the tilting frame slides along with and on top of the extension frame, wherein the tilting frame begins moving from the down position to the up position upon engagement with the tilt initiator;
(g) a cargo carrier mounted on the tilting frame, wherein the cargo carrier comprises a first end and a second end, the cargo carrier being slidably moveable between a first position and a second position, wherein in the first position, the first ends of both the cargo carrier and the tilting frame are aligned with each other, wherein in the second position the second end of the cargo carrier extends to the surface rearward of the vehicle; and
(h) means for slidably moving the cargo carrier between the first position and the second position.

2. The system of claim 1, wherein the means for slidably moving the extension frame between the forward position and the rearward position and the means for hingedly moving the tilting frame between the down position and the up position are one mechanism.

3. The system of claim 1, wherein the means for slidably moving the extension frame between the forward position and the rearward position comprises a hydraulic system comprising of at least one hydraulic cylinder.

4. The system of claim 1, wherein the means for hingedly moving the tilting frame between the down position and the up position comprises a hydraulic system comprising of at least one hydraulic cylinder.

5. The system of claim 1, wherein the means for slidably moving the cargo carrier between the first position and the second position is selected from a group consisting of at least one winch and a wire rope, chain and chain drive and rack and gear motor.

6. The system of claim 1, further comprising a first plurality of stoppers to limit the movement of the extension frame between the forward position and the rearward position and a second plurality of stoppers to limit the movement of the cargo carrier between the first position and the second position.

7. The system of claim 1, further comprising at least one shock absorption device.

8. The system of claim 1, further comprising a user operated control unit to remotely activate the system.

9. The system of claim 1, further comprising a plurality of cargo securing points on the cargo carrier.

10. The system of claim 1, further comprising a plurality of locking devices to secure the cargo carrier at specific points between the first position and the second position.

11. The system of claim 1, further comprising a plurality of outwardly extending rollers on the tilting lateral member that allows the cargo carrier to slide between the first position and the second position.

12. The system of claim 1, wherein the vehicle is selected from a group consisting of a light truck, medium truck, heavy truck, pick-up truck, utility vehicle, sport utility vehicle, wagon, station wagon, off-road vehicle, all terrain vehicle, golf cart, van, cargo van, panel van, pick up van, panel truck, canopy express, tow truck, flat bed tow truck, box truck, cutaway van chassis, bus, minibus, ambulance, school bus, delivery truck, motor home, shuttle bus, fire truck, flatbed truck, trailer, fifth wheel trailer, caravan, armored truck, dump truck, garbage truck and a tractor.

13. The system of claim 1, further comprising a plurality of locking devices to secure the tilting frame at specific points between the down position and the up position.

14. The system of claim 1, further comprising a plurality of locking devices to secure the extension frame at specific points between the forward position and the rearward position.

15. The system of claim 1, wherein the extension frame further comprises a plurality of cross members.

16. The system of claim 1, wherein the tilt initiator comprises at least one lift ramp attached on top of at least one of the base cross members and at least one rotatable ramp roller attached to one of the tilting cross members wherein as the extension frame is moved between the forward position and the rearward position, the tilting frame slides along with and on top of the extension frame until the ramp roller rotably engages the lift ramp such that the ramp roller rolls onto and up the lift ramp to initiate moving the tilting frame from the down position to the up position.

17. The system of claim 1, wherein the tilt initiator comprises at least one lever attached to at least one of the base cross members and at least one of the tilting cross members, wherein as the extension frame is moved between the forward position and the rearward position, the tilting frame slides along with and on top of the extension frame and the lever leverages the tilting frame initiating the movement of the tilting frame from the down position to the up position.

18. The system of claim 1, the system further comprising a winch and wire rope for loading and unloading cargo onto the cargo carrier.

19. The system of claim 1, wherein the constraints of the vehicle comprises standard enclosures of a mass produced vehicle, further wherein system of claim 1 may be attached to the vehicle without modification to the standard enclosures.

20. The system of claim 1, wherein the surface rearward of the vehicle is selected from a group consisting of a dock, the ground, water or the flat surface of a second vehicle.
